(19) United States
(12) Patent Application Publication
(10) Pub. No.: US 2019/0244149 A1
(43) Pub. Date: Aug. 8, 2019

(54) Cognitive Intelligent Automation Systems for Actionable Business intelligence (CIASFABI©)

(71) Applicant: Sankar Krishnaswamy, Round Rock, TX (US)

(72) Inventor: Sankar Krishnaswamy, Round Rock, TX (US)

(21) Appl. No.: 16/024,061

(22) Filed: Jun. 29, 2018

Related U.S. Application Data
(60) Provisional application No. 62/591,007, filed on Nov. 27, 2017.
(60) Provisional application No. 62/599,448, filed on Dec. 15, 2017.

(51) Int. Cl. G06Q 10/06; G06N 5/02

(52) U.S. Cl. CPC G06Q 10/0637; G06N 5/02

(57) ABSTRACT

A method and systems comprising cognitive intelligent automation systems (CIASFABI©), that transforms any customer's information systems to provide actionable business intelligence at every stage of the evolution to the ultimate target system, the best in class in the industry at any stage 24×7, seamlessly, similar to autonomous cars except in this case, information systems that run your business—eCommerce, ERP, CRM, Analytics etc., always adjusting to internal and external events to take advantage of opportunity, to provide 24×7 Reports, Checklists, Roadmaps and advice on Strategic, tactical and operational execution, on all areas/lines of the business (LoBs):—ecommerce, ERP, CRM, BW/BI, Product life cycle management (PLM), LoB, Products & Services, Infrastructure, corporate vulnerability while ensuring the corporate mission, culture, history and image are well protected and nourished supporting Executive management, C level executes, end-to-end Lines of Business (LOB), senior management and Board of Directors

The automation system is amenable to learn further by neural networks, Artificial Intelligence, Machine Language/Robotic Process Automation Scripts (Bots), In Memory computing technology (e.g. SAP S4HANA), Internet of Things and different adapter & sensors, adjusting the customer's information systems autonomously.

### RELATED APPLICATIONS

The present application is a continuation-in-part to US provisional applications—Application No. 62/591,007 customer number 152451 dt Nov. 27, 2017 and Application No. 62/599,448 customer number 152451 dt Dec. 15, 2017. In addition, this patent refers related commercial applications such as SAP Leonardo S4HANA (Latest Enterprise Resource Planning from SAP Inc) —latest offering on Artificial intelligence and Enterprise Resource Planning platform from a vendor SAP, Leonardo Internet of Things. Artificial intelligence, Robotic Process Automation, Neural networks, machine to machine learning, standard packaged enterprise applications (e.g. SAP).

### FIELD OF THE INVENTION

Embodiment of the present invention generally relate to a method and system(s) suite of self-generating, semi-autonomous Cognitive Intelligent Automation systems that can provide actionable business intelligence and automation solutions to any business enterprise—small business to Fortune 500 companies who have standard Commercial Off the Shelf (COTS)/packaged applications (e.g. SAP.) for providing innovative and much improved approach for transforming existing customer's information systems using customized intelligent automation solutions using Artificial intelligence, Robotics Process Automation, Neural Networks and Machine-to-Machine learning, Internet of Things, Blockchain, Mobility, In-Memory computing, Big Data Analytics the best-in-class information systems for the company within their industry.

### BACKGROUND OF THE INVENTION

Many businesses have the same need for business intelligence—strategic, tactical, operational to ensure long-term profitability of business and often they can only do piece-meal implementation of certain key systems to give part of the business intelligence but never a collective one based on their rich history, culture, information systems maturity. In addition, many client's business systems have many important business processes that can be automated but have not been done or even attempted to a large extent. The cognitive intelligent automation systems will attempt to automate most of the business process to enable operational excellence in the company with state-of-the art information systems.

Many of the existing enterprise systems are mainly operational systems with some limited analytics and the business intelligence is not all pervasive and the systems rarely provide checklists & roadmaps to C level executives and Board of Directors, on a daily/weekly/monthly/yearly basis, as suggested in the proposed Artificial intelligence based proposed Cognitive intelligent automation solution/system. Also, these systems lack automation of business process to the fullest potential as suggested in proposed Cognitive intelligent automation solution/system.

In the extreme nature of competitive world with established companies run over by new entrants, companies are slow to react to emerging technologies threatening their very own existence, because they don't have 24-hour intelligent Cognitive Intelligent Automation systems that constantly look for opportunity and threats and provide appropriate advice in a timely manner the top management including real-time checklists, roadmaps etc.,

Though many new technologies (e.g. SAP) such as cloud computing, in-memory technologies (HANA), SAP Leonardo S4HANA (latest offering on Artificial intelligence and Enterprise Resource Planning platform from a vendor SAP), Machine Learning enhanced Robotic Process Automation (RPA), Artificial intelligence, Internet of Things, SAP Leonardo, Big Data analytics are available and being used for some key information systems, there is no concept, idea or system available till date that can transform existing systems, adjust their information systems with self-curing and/or fine tuning measures to provide target best-in-class system(s) with semi/near autonomous actionable business intelligence for the companies, pretty much all across the enterprise on all strategic, operational and tactical decision making.

### Rationale

Research done so far is not super practical for many companies to let a third-party system decides the course of core information systems hence it is hoped this idea, concept and solution will bridge the gap to make every organization's business system to elevate to the highest-level intelligent information systems best-in-class in the industry that will provide business intelligence to the entire management and Board of Directors and various divisional managers, in every step of their digital transformation from existing system to the best-in class systems and appropriate governance to remain best-in-class systems.
Market opportunities—Huge untapped market potential to address business intelligence and automation needs of their own information systems of any organization from small to Fortune 500.
Alignment with corporate mission, goals & objectives of the customers to systems that support—this solution will bridge the gap and fulfill the founder's original intent for starting the organization and keep the target systems aligned with corporate missions, goals and objectives.
Current resources/technology are too transaction oriented and lack the wisdom to take organizations to the next 10 to 50 years due to the impact of internal/external events/systems. Our Cognitive Intelligent Automation systems (proposed Cognitive intelligent automation solution/system) will provide guidance and actionable intelligence to take them every day and in the future weeks and months and not like many systems that aim to provide roadmap in increments of 5 years, with more adjusted goal set in mind. Here the Roadmaps generated by proposed Cognitive intelligent automation solution/system are real-time considering internal (systems and events) and external events/systems.

### SUMMARY

The Cognitive Intelligent Automation System (proposed Cognitive intelligent automation solution/system) with foundation architecture including SAP Leonardo S4HANA (latest offering on Artificial intelligence and Enterprise Resource Planning platform from a vendor SAP), Internet of Things with custom technology (including and not limited to Internet of Things sensors for all existing/target systems and subsystems) will be installed on-premise or cloud to interact with customer's systems.
After few weeks of fine tuning after interaction of “Master proposed Cognitive intelligent automation solution/system” achieved through amalgamation of Cognitive intelligent automation solutions of several industries and companies)/proposed Cognitive intelligent automation solution/system (Basic) (initial first-cut solution)/proposed Cognitive intelligent automation solution/system (Advanced) (fine-tuned to be close to best-in-class with the existing/target information systems, scope of business intelligence and automation solutions needed in various areas will be identified in various phases. Series of Mini-Cognitive Intelligent Automation Adapters/Systems will be generated to provide Actionable Business intelligence reports, checklist, guidelines will be generated and can be fine-tuned and any corrections can be fed into (Master proposed Cognitive intelligent automation solution/system) Cognitive solution setup, to generate better business intelligence and automation solutions in the next iteration(s). Also, various automation solutions including Machine Learning/Robotic Process Automation BOTS software roBOTS/Virtual agents will be generated to provide full automation to the company's business information systems.
Initial phase of implementation will be for eCommerce, Enterprise Resource Planning, Customer Relationship Management and Analytics. Additional phases covering other areas of business will also be implemented. For multi-national companies—special rollout tools, technologies and methodologies will be provided.
Initial Implementation of Enterprise Resource Planning, eCommerce, Customer Relationship Management and Analytics will be from SAP systems to latest version of SAP Leonardo S4HANA (latest offering on Artificial intelligence and Enterprise Resource Planning platform from a vendor SAP); Subsequent implementation will be supporting other packaged solutions from various vendors (e.g. Oracle, Sage, Infor, Microsoft)
All external events/systems affecting the company will be analyzed and advice will be provided from the Master proposed Cognitive intelligent automation solution/system/system to customer's proposed Cognitive intelligent automation solution/system—Basic, Advanced, Ideal_virtual (target ideal system), Virtual_company (target company system), each iteration of the product will provide superior intelligence than the previous one. If there are opportunities to upgrade the versions to the latest available and/or change from on-premise to cloud, such recommendations will also be provided. Option will be provided to lock all of proposed Cognitive intelligent automation solution/system/systems—Basic, Advanced, Ideal_Virtual, Virtual_company.
The necessary systems, technology (inhouse and from partner companies (vendors, systems integrators, technology partners) and customize further, the Cognitive Intelligent Automation setup to work with the Customer's unique business systems to produce the checklist, roadmaps and Actionable Business intelligence reports and drive the entire business systems (ecommerce, Enterprise Resource Planning, Customer Relationship Management, Analytics and other systems) that support latest innovation through Artificial intelligence and Cognitive Automation.
Additional benefits of the Cognitive Intelligent Automation for Alignment of corporate mission, goals and objectives with Business Intelligence needs provided by current/proposed company initiatives enhanced by the recommendations provided by virtual company of Cognitive Intelligent Automation system (proposed Cognitive intelligent automation solution/system), identifying the gaps in their existing initiatives and approach and provide suitable reports to close the gap.
By Combining proponents of Artificial intelligence and cognitive computing in a single operating environment using the same sets of data, we propose to revolutionize existing customer's information systems to be a self-evolving cognitive intelligent automation systems where it not only knows the ultimate target information systems (e.g. SAP S4HANA 1809 (Enterprise Resource Solutions)) but also how to get there every step of the way seamlessly, very similar to what autonomous cars take you to the destination, except in this case, to the target information systems that will run your business-eCommerce, Enterprise Resource Planning, Customer Relationship Management, Analytics etc. In addition, should the customer prefer an earlier and proven version instead of the latest, proposed Cognitive intelligent automation solution/system will guide the target system to that version desired by customer.
To summarize, (proposed Cognitive intelligent automation solution/system) is a set of cognitive intelligent automation systems that can be adapted to different company's enterprise information system architecture, amenable to learn further by neural networks, Artificial intelligence, Machine Learning/Robotic Process Automation BOTS software roBOTS/Virtual agents, In Memory computing technology (e.g. SAP S4HANA), Internet of Things, SAP Leonardo platform and different adapter & sensors with the sole purpose of providing actionable business intelligence reports, checklists, roadmaps to all C level executives, Board of Directors and all executive management as well as the ideal target information systems with minimal disruption to organization, processes and people.
Finally, a prototype of (proposed Cognitive intelligent automation solution/system) will be made using SAP Leonardo S4HANA (latest offering on Artificial intelligence and Enterprise Resource Planning platform from a vendor SAP) (Artificial intelligence, Internet of Things platform), Internet of Things, Machine Learning/Robotic Process Automation BOTS software roBOTS/Virtual agents, Artificial intelligence, Big Data Analytics together with indigenous MACHINE TO MACHINE (machine-to-machine) and neural networks, to showcase the concept, product that will transform a typical say SAP based enterprise applications (e.g. SAP ECC) with a superior wisdom provided by this product for the entire enterprise using state-of-the-art Artificial intelligence using Deep Learning and Neural Networks and Cognitive Intelligent Automation with Machine Learning (Machine Learning/Robotic Process Automation (Robotic Process Automation) BOTS software roBOTS/Virtual agents to SAP Leonardo S4HANA (latest offering on Artificial intelligence and Enterprise Resource Planning platform from a vendor SAP) including any appropriate industry solution applicable to the customer (e.g. SAP Retail. Manufacturing, Oil & Gas etc.).

### Major Benefits

Cognitive intelligent automation system (proposed Cognitive intelligent automation solution/system) which can be attached to any customer systems running standard COTS (Commercial off the shelf System) package (e.g. SAP to start with and other 3^{rd} party COTS in the future) to provide:
a. As a first step, an appropriate cognitive intelligent automation solution that works with existing customer package versions etc. (e.g. SAP ECC 6 Enh pk 4, Business Warehouse, Customer Relationship Management, Hybris 5.x, Oil & Gas Industry solution etc.) and suggest the best and most used, fully supported for the industry (e.g. Oil & Gas), and latest version for their future system (e.g. SAP S4HANA 1809 Oil & Gas IS, with BW/4HANA, (SAP Business Warehouse on S4HANA platform, Hybris 6.7 etc.). Existing system will also be analyzed for
   1. core business processes that have potential automation opportunities which are currently executed manually at enormous cost. Also checks how well the automation opportunity compares with best practices within same industry and across all industries.
   2. Infrastructure vulnerability and potential for improvements
   3. Security vulnerabilities including. cyber security threats
   4. Identify business process, and/or other software that might be enabled (which are not at present) based on the best practices of other companies in the same industry or even across industries.
   5. Existing information system software (e.g. SAP ECC enhancement pack 4, Hybris 5.5 etc.) is constantly monitored with the IdealVirtual® system (Ultimate target system) and company_virtual (chosen current target system) and a percentage of maturity (Capability Maturity Ranking) will be provided to customer real-time as actionable business intelligence, so the customer can decide to transform to the best-in class solutions. (to the ideal_virtual system)
b. Customer may decide to upgrade to the recommended versions and if so appropriate roadmaps for upgrade to new system (called the IdealVirtual® system) will be provided. The customer can choose this latest version or even lower version to be the target company system (Virtual_company)
c. The cognitive intelligent automation solution will work with both upgraded system and the existing version of the customer system.
d. Actionable business intelligence and Compliance Reporting for all C level executives, Executive management Divisional managers and Board of Directors providing checklists, roadmaps, Alerts incl. SWOT (Strength, weakness, opportunity & Threats) analysis
e. Advice on strategy, tactical and operational execution on all areas/lines of the business:—ecommerce, Enterprise Resource Planning, Customer Relationship Management, Business Warehouse/Business Intelligence, Product life cycle management (PLM), lines of the business: Products & Services, Infrastructure, corporate vulnerability while ensuring the corporate mission, culture, history and image are well protected and nourished with the assistance of the system from now on will be called proposed Cognitive intelligent automation solution/system, specifically company_virtual_proposed Cognitive intelligent automation solution/system.
f. Actionable business intelligence products include but not limited to Predicting infrastructure needs from present to 1-2-5 years, new products & services, new Mergers & Acquisitions opportunities, Actionable strategic, operational intelligence, predicting & mitigating corporate vulnerabilities, corporate governance for Board of Directors, employees, shareholders, identifying the gaps in their existing initiatives and approach and provide suitable reports to close the gap, in their quest to evolve to an appropriate target system.
g. Initial phase of implementation will be for eCommerce, Enterprise Resource Planning, Customer Relationship Management and Analytics. Additional phases covering other application areas of business will also be implemented
h. For multi-national companies—special rollout methodologies will be provided.
i. Initial Implementation of Enterprise Resource Planning, eCommerce, Customer Relationship Management and Analytics will be from SAP systems to SAP Leonardo S4HANA (latest offering on Artificial intelligence and Enterprise Resource Planning platform from a vendor SAP); Subsequent implementation will be supporting other packaged solutions from various vendors (e.g. Oracle, Sage, Infor, Microsoft)
j. After few weeks of fine tuning of interaction with the information systems (current, target ideal system, target chosen company virtual system), scope of business intelligence and automation solutions needed in various areas will be identified in various phases. Series of Mini-Cognitive Intelligent Automation Adapters/Systems will provide Actionable Business intelligence reports, checklist, guidelines will be generated and can be fine-tuned and any corrections can be fed into (Master proposed Cognitive intelligent automation solution/system) Cognitive solution setup, to generate better business intelligence in the next iteration(s). Also, various automation solutions including Robotic Process Automation BOTS software roBOTS/Virtual agents will be generated to provide full automation to the company's business systems and evolve to the ideal target system.
k. License purchased will determine the customer's proposed Cognitive intelligent automation solution/system including all adapters and mini-cognitive systems and will be enforced by custom technologies (including but not limited to block-chain technologies)
l. Custom tools, methodology and consulting to partners and customers will be provided to fine tune the proposed Cognitive intelligent automation solution/system/system, for the customer's unique enterprise system(s). (i.e., virtual_company system)
m. Feedback control mechanism will be provided to fine tune the Cognitive Intelligent Automation systems, based on change in market place, laws, technology, etc. due to external events/Systems.
n. Finally, all external events affecting the company will be analyzed and advice will be provided from the Master proposed Cognitive intelligent automation solution/system to customer's proposed Cognitive intelligent automation solution/system, each iteration of the product will provide superior intelligence than the previous one.

### BRIEF DESCRIPTION OF DRAWINGS

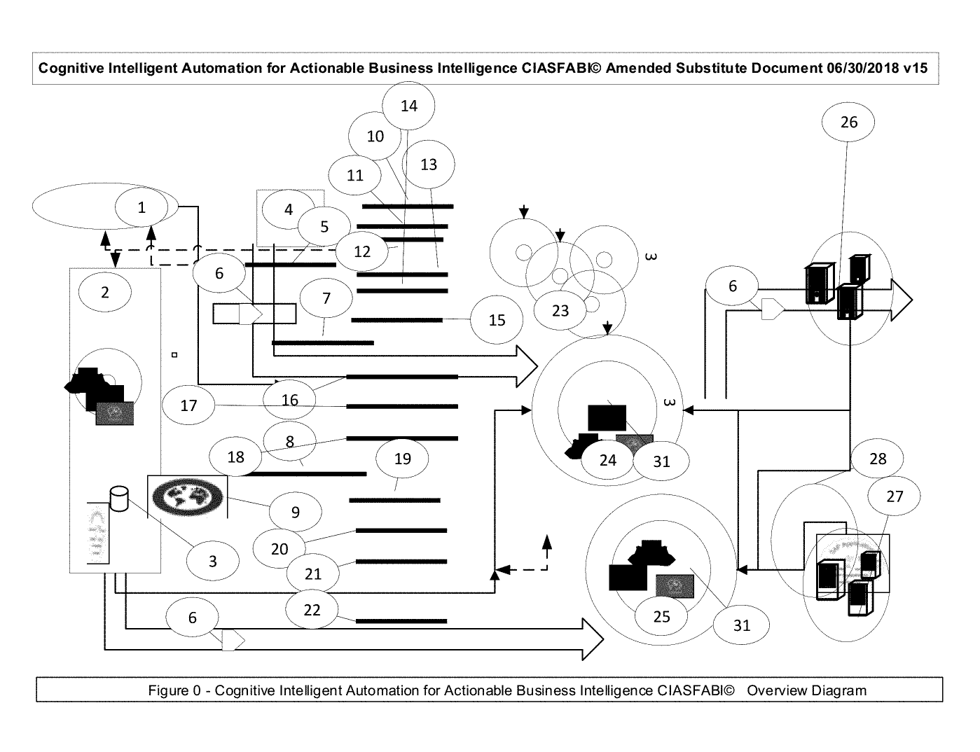

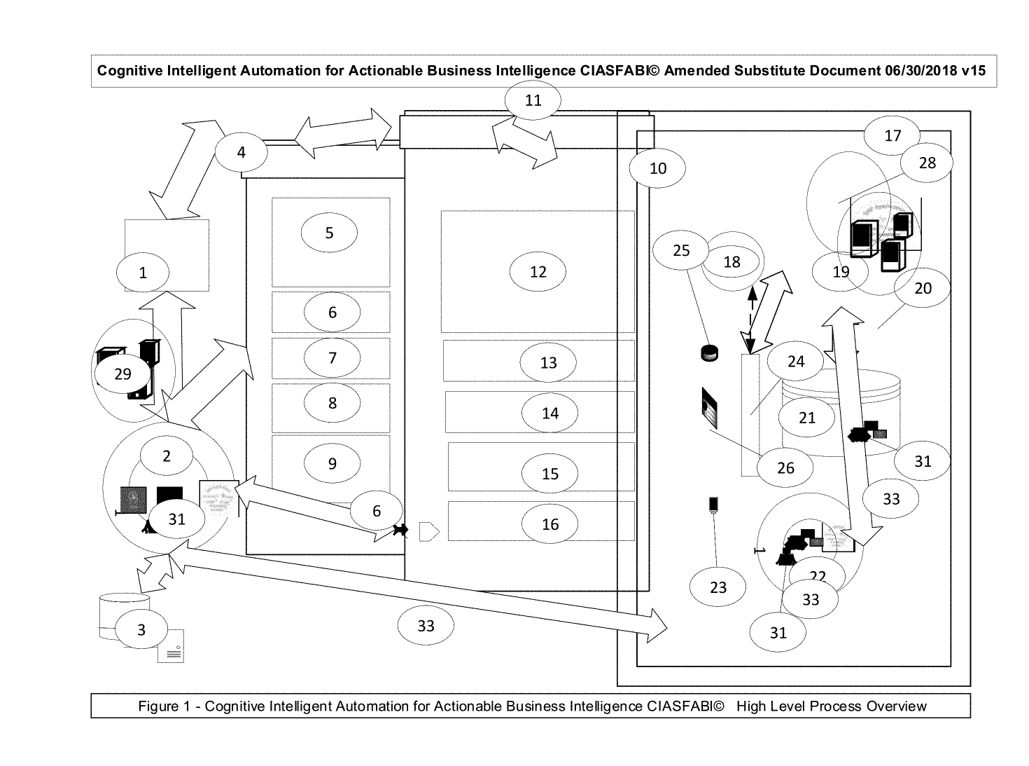

FIG. 0—High level Architecture overview
1. proposed Cognitive intelligent automation solution/system SetupWizard
2. Master proposed Cognitive intelligent automation solution/system
3. Cognitive Super DB
4. Existing Information Systems
5. License
6. Connectivity Test
7. Discovery Phase
8. Implementation Phase
9. SWOT from External Events/Systems
10. Enterprise Resource Planning
11. Business Warehouse/Business Intelligence
12. eCommerce
13. Big Data
14. Manufacturing Systems
15. PLM
16. Identify Opportunity Matrix
17. Understand Platform Specifics
18. Prioritize based on benefits/customer inputs
19. Quickwins
20. Complexity (Moderate, Medium, Futuristic)
21. Understand/Refine Platform Specifics
22. Prioritize including refinement based on benefits/customer inputs
23. Artificial intelligence based proposed Cognitive intelligent automation solution/system Adapters
24. proposed Cognitive intelligent automation solution/system (Basic)
25. proposed Cognitive intelligent automation solution/system (Advanced)
26. Existing Enterprise Systems
27. Virtual company Enterprise Systems
28. Ideal Virtual Enterprise Systems proposed Cognitive intelligent automation solution/system
29.
30.
31. Artificial intelligence, Machine Learning, Deep Learning/Neural Networks, Robotic Process Automation
The Cognitive Intelligent Automation systems using Artificial System architecture is designed to provide the necessary systems, processes and technology to take existing information systems (1) to provide the ideal ultimate information systems for the customers (28), based on data driven machine learning and deep learning approach with lot of examples and training combined with process automation through explicit representations and rules aided by Robotic Process Automation (Robotic Process Automation s), exception handling. Both Data driven Artificial intelligence and Process driven Artificial intelligence are controlled by a best practices Artificial intelligence database (Master proposed Cognitive intelligent automation solution/system) which itself is constantly being improved in each iteration which is officially released every 3 months.
Existing customer's information systems (1) licenses (5) are authenticated, before analyzing all their systems (Enterprise Resource Planning (10), Business Warehouse/Business Intelligence (11), eCommerce (12), Big Data (13), Product Lifecycle Management (15), Manufacturing Systems (14) etc.) in any of the industry specific implementations (Retail, Oil & Gas, Hitech, Pharma, Industrial machinery & components, Automotive, Chemical, Pharma, Aerospace & Defense, Consumer Packaged Goods, Apparel Footwear Solutions etc.) to come with a Basic version of cognitive intelligent automation proposed Cognitive intelligent automation solution/system Basic, as directed by the Master proposed Cognitive intelligent automation solution/system hosted in a datacenter. All of the customer's systems and datacenter systems are tested for connectivity during wizard's guided configuration. Further Discovery and implementation phases including SWOT (Strength, weakness, opportunity & Threats) analysis of internal/external events improve the customer's cognitive information system to be proposed Cognitive intelligent automation solution/system Advanced which is used to Create/finetune/update the ideal system (target ideal_Virtual system—ultimate Target system) Virtual company information systems (Virtual_company Chosen Target system) for the specific company.
The Cognitive Intelligent automation system proposed Cognitive intelligent automation solution/system analyzes the existing information systems (e.g. SAP systems—Enterprise Resource Planning, Customer Relationship Management, BW, eCommerce etc.) with customer's intended ultimate platform (ideal_virtual) and finds the best versions of the software as recommended by SAP through Product Availability Matrix. If an on-premise is desired by the customer but the best versions and features suiting customer's needs are only available in Cloud offering, the same will be recommended but the customer can still insist on only on-premise implementation with the understanding less optimal ultimate system will be available and that will be the company's target system (virtual_company).
The Master Cognitive intelligent automation system (Master proposed Cognitive intelligent automation solution/system (2)) will be the Artificial intelligence repository (Cognitive Super DB (3)) using leading technologies—Machine Learning, Internet of Things, Block chain, Robotic Process Automation, In-memory computing, Deep Learning, Mobility and Artificial Intelligence Platform with the foundation architecture based on SAP Leonardo that provides guided assistance (proposed Cognitive intelligent automation solution/system SetupWizard (1)) (Configuration, testing, Proof of Concept, System-wide testing, Data Migration, Integration testing, cutover assistance and checklist for the implementation team for smooth implementation)
The proposed Cognitive intelligent automation solution/system Solution is supported by Foundation Architecture—SAP Leonardo S4HANA (latest offering on Artificial intelligence and Enterprise Resource Planning platform from a vendor SAP) based Internet of Things and Artificial Intelligence environment, a combination of intelligent technologies, services, and industry solutions to provide innovative customized solutions for each customer
All existing Enterprise information systems (26) for customer will be fitted with sensors and Internet of Things enabled, will be tested for Single-sign-on during connection test (6) with Master proposed Cognitive intelligent automation solution/system (2), proposed Cognitive intelligent automation solution/system Basic (24), proposed Cognitive intelligent automation solution/system Advanced (25), Ideal_virtual (28), Virtual Company Enterprise Systems (27), to ensure that necessary configuration data, Master Data, Transaction data can be read and written with authorization as a proposed Cognitive intelligent automation solution/system Superuser.
proposed Cognitive intelligent automation solution/system Setup Wizard (1), with guidance from Artificial intelligence Master DB-Master proposed Cognitive intelligent automation solution/system (2), after connection test (6) during Discovery Phase (7) will read from Existing information systems (4) (26) will produce “identify Opportunity Matrix” (16) which essentially identifies all solution advancement possible from current systems to ultimate information system (28), Chosen Target system-virtual_company (27). The Discovery (7) also produces “platform specifics —reports (17)” which is also used in the possible solutions in the ultimate information systems (27). Discovery (7) also prioritize the solutions based on benefits with user's input (18) and will be used in the possible solutions in the ultimate information systems (28), Chosen Target system-virtual_company (27).
Proposed Cognitive intelligent automation solution/system Setup Wizard (1), with guidance from Artificial intelligence Master DB-Master proposed Cognitive intelligent automation solution/system (2), after connection test (6) during Implementation Phase (8) will use Discovery Phase results (17) (18) along with SWOT (Strength, weakness, opportunity & Threats) analysis of external events/systems will produce “Quickwins” (16) and solutions based on complexity (Moderate/Medium/Futuristic) of solutions for ultimate information system (28), Chosen Target system-virtual_company (27). The Implementation Phase (8) will refine and fine tune “platform specifics—reports (21)” and also refine and fine tune prioritize the solutions based on benefits with user's input (22) and will be used in the possible solutions in the ultimate information systems 28), Chosen Target system-virtual_company (27).
The following Artificial intelligence based proposed Cognitive intelligent automation solution/system adapters (23), as given below, will generate mini Cognitive system using customized Machine Learning/Robotic Process Automation BOTS software roBOTS/Virtual agents will be used to transform the current information systems to the ultimate information systems (28), more like an Autonomous Cars except that in this case it will be information systems—knows where to go from where they are and take their information systems, organizations, processes along with it
   Preliminary Adapters (Industry, Company, Region, Country, Size)
   Company Specific Adapters based on
      systems (eCommerce, Enterprise Resource Planning, BI, PLM)
      Lines of Business
      Products/Services
      Infrastructure—Present & Future
      Historical reporting/BI—Present & Future
Various Artificial intelligence based proposed Cognitive intelligent automation solution/system Adapters (23) as given above will create the first cut Artificial intelligence based repository for this customer (proposed Cognitive intelligent automation solution/system—Basic (24) which will be refined to proposed Cognitive intelligent automation solution/system—Advanced (25), ultimate information system (28), Chosen Target system-virtual_company (27) (which can be either the best version or even version than the ideal target system), based on guidance from Master proposed Cognitive intelligent automation solution/system Artificial intelligence repository (2) to produce the Virtual Company Enterprise systems for the customer (27) with foundations architecture provided by SAP Leonardo supporting Internet of Things, Blockchain, Artificial intelligence, Machine Learning, In-memory computing, Industry 4.0, Mobility FIG. 1—High level Process Diagram
1. Next iteration of Cognitive Intelligent Automation solution. Preliminary Adapters (Industry, Company, Region, Country, Size)
2. Master proposed Cognitive intelligent automation solution/system
3. Cognitive Super DB
4. Existing Company
5. Company Specific Adapters on systems (eCommerce, Enterprise Resource Planning, Business Intelligence (BI), Product Life Cycle Management (PLM)
6. Company Specific Adapters based on Line of Business (LOB)
7. Company Specific Adapters based on Products/Services
8. Company Specific Adapters based on Infrastructure—Present & Future
9. Company Specific Adapters based on Historical reporting/BI—Present & Future
10. Virtual company with Cognitive intelligence
11. Cognitive Management Systems
12. Business Score Card (BSC), Infrastructure, corporate performance, cyber security, vulnerability, new products/services, R&D, Strategic Information systems
13. Recommended systems, BI Reports, Actions
14. Rejected by Customers incl. reasons and when this can be revisited
15. Evolving Cognitive BI trends within the company
16. Evolving External cognitive BI trends
17. Prebuild Analyzer
18. cognitive intelligent automation prebuild wizard
19. Company Virtual proposed Cognitive intelligent automation solution/system
20. Cognitive Automation Analyzer
21. PreBuild_BOTS software roBOTS/Virtual agents proposed Cognitive intelligent automation solution/system (Basic)
22. proposed Cognitive intelligent automation solution/system (Advanced)
23. Monitor Progress
24. Governance
25. Company Configuration
26. Company knowledgebase
27.
28. Existing Enterprise Systems
29.
30.
31. Artificial intelligence, Machine Learning, Deep Learning/Neural Networks (DL/NN)
32. connectivity test
33. Update/Finetune
   Most of the explanations for FIG. 0 are also applicable to FIG. 1
Setup using infrastructure assistant Single Sign-on (SSO) and Secured infrastructure. Test connectivity (32)
Access Cognitive Management (11) system to setup preliminary Cognitive DB for the industry, company using Machine Learning/Robotic Process Automation BOTS software roBOTS/Virtual agents
The following Artificial intelligence based proposed Cognitive intelligent automation solution/system adapters (1)(5)(6)(7)(8)(9), as given below, will generate mini Cognitive system using customized Machine Learning/Robotic Process Automation BOTS software roBOTS/Virtual agents will be used to transform the current information systems to the ultimate information systems (28) and customer chosen target system—Virtual company with Cognitive Intelligence (10), more like an Autonomous Cars except that in this case it will be information systems—knows where to go from where they are and take their systems, organizations, processes along with it
   Preliminary Adapters (Industry, Company, Region, Country, Size) (1)
   Existing Company Specific Adapters based on
      i. systems (eCommerce, Enterprise Resource Planning, Business Intelligence (BI), Product Life Cycle Management (PLM) (5)
      ii. Line of Business (LOB) (6)
      iii. Products/Services (7)
      iv. Infrastructure—Present & Future (8)
      v. Historical reporting/BI—Present & Future (9)
Analyze Past, present and future BI reports/activities setup in existing systems with the proposed from Cognitive automation system. Measure the Gaps. Create guidelines, recommendations using Cognitive automation system for new infrastructure, new information systems, new products and services, etc. Get feedback from customers, grade, evaluate and finalize the target system including the versions. Additional benefits of the Cognitive Intelligent Automation for Alignment of corporate mission, goals and objectives with Business Intelligence needs provided by current/proposed company initiatives enhanced by the recommendations provided by ideal_virtual (28) and virtual_company (10) of Cognitive Intelligent Automation system (proposed Cognitive intelligent automation solution/system), (10), identifying the gaps in their existing initiatives and approach and provide suitable reports to close the gap.
   The Ideal_Virtual company with cognitive intelligence (28) after analyzing Business Score Card (BSC), Infrastructure, corporate performance, cyber security, vulnerability, new products/services, R&D, Strategic Information systems (12), produces the following analytical reports which are either approved or rejected by user management.
      i. Recommended systems, Business Intelligence (BI) Reports, Actions (13)
      ii. Rejected by Customers incl. reasons and when this can be revisited (14)
      iii. Evolving Cognitive Business Intelligence (BI) trends within the company (15)
      iv. Evolving External cognitive Business Intelligence (BI) trends (16)
This user management input is fed to Prebuild analyzer (17) to finalize company specific Virtual_proposed Cognitive intelligent automation solution/system i.e., the absolute ideal target system for the specific company (10).
The Cognitive Automation Analyzer (20) reads current company configuration (25) of systems and additional company specific knowledgebase (26) and uses Various Artificial intelligence based proposed Cognitive intelligent automation solution/system Adapters (1)(5)(6)(7)(8)(9) as given above will create the first cut Artificial intelligence based repository for this customer (proposed Cognitive intelligent automation solution/system—Basic (21) which will be refined, based on guidance from Master proposed Cognitive intelligent automation solution/system Artificial intelligence repository (2) Ideal_virtual (28) and the Virtual Company Enterprise systems for the customer (10) to proposed Cognitive intelligent automation solution/system—Advanced (22) with foundations architecture provided by SAP Leonardo supporting Internet of Things, Blockchain, Artificial intelligence, Machine Learning, In-memory computing, Industry 4.0, Mobility solutions
The Cognitive Automation Analyzer Governance (24) makes sure it ensures all current systems configuration, Master data, and (sample/full) transaction data are transferred and validated with user inputs to ideal_virtual (28), Company_Virtual proposed Cognitive intelligent automation solution/system (19), proposed Cognitive intelligent automation solution/system—Basic (21), proposed Cognitive intelligent automation solution/system—Advanced (22), The progress of the transfer and validation are monitored (23) along with percentage of completion.
Fine tune Cognitive DB repository (3) for the Master proposed Cognitive intelligent automation solution/system (2) with company specific information incl. details on Information systems etc. How well did the new solution help the company—SWOT (Strength, weakness, opportunity & Threats) analysis, recommendations for improvements to Cognitive Automation systems in the next iteration. The results are once again used to update the Master proposed Cognitive intelligent automation solution/system (2)

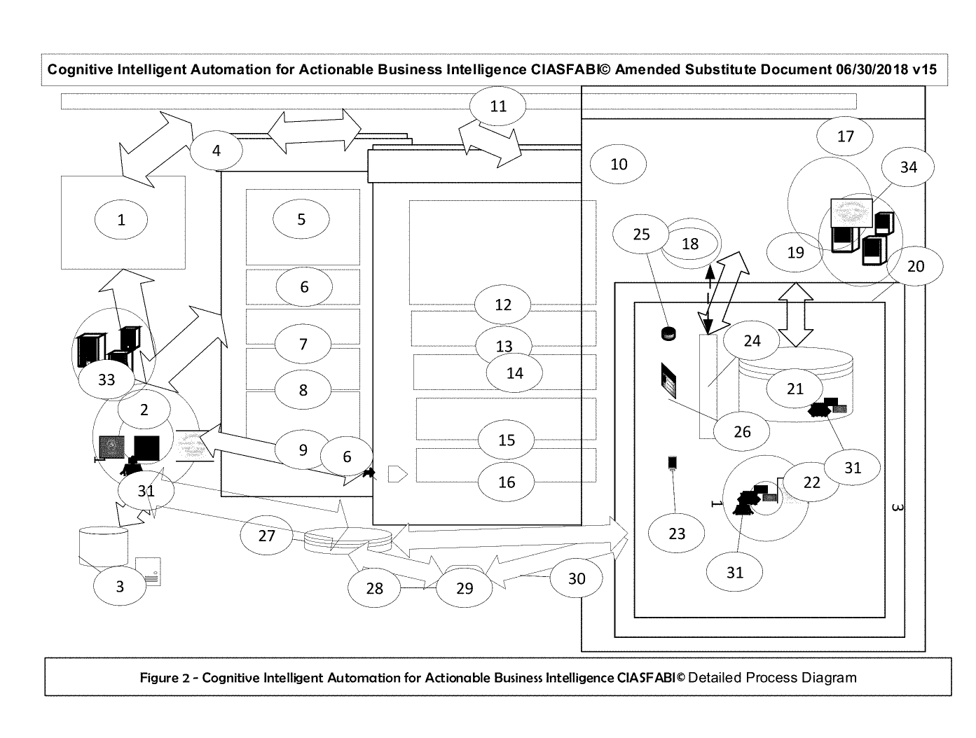

FIG. 2—Detailed Process Diagram
1. Preliminary Adapters (Industry, Company, Region, Country, Size)
2. Master proposed Cognitive intelligent automation solution/system
3. Cognitive Super DB
4. Existing Company
5. Company Specific Adapters on systems (eCommerce, Enterprise Resource Planning, Business Intelligence (BI), Product Life Cycle Management (PLM)
6. Company Specific Adapters based on Line of Business (LOB)
7. Company Specific Adapters based on Products/Services
8. Company Specific Adapters based on Infrastructure—Present & Future
9. Company Specific Adapters based on Historical reporting/BI—Present & Future
10. Virtual company with Cognitive intelligence
11. Cognitive Management Systems
12. Business Score Card (BSC), Infrastructure, corporate performance, cyber security, vulnerability, new products/services, R&D, Strategic Information systems
13. Recommended systems, BI Reports, Actions
14. Rejected by Customers incl. reasons and when this can be revisited
15. Evolving Cognitive BI trends within the company
16. Evolving External cognitive BI trends
17. Prebuild Analyzer
18. cognitive intelligent automation prebuild wizard
19. Company Virtual proposed Cognitive intelligent automation solution/system
20. Cognitive Automation Analyzer
21. PreBuild_BOTS software roBOTS/Virtual agents proposed Cognitive intelligent automation solution/system Basic
22. proposed Cognitive intelligent automation solution/system Advanced
23. Monitor Progress
24. Governance
25. Company Configuration
26. Company knowledgebase
27. Master proposed Cognitive intelligent automation solution/system
28. Releases every 3 months
29. External Events
30. Releases every 3 months
31. Artificial intelligence, Machine Learning, Deep Learning/Neural Networks (DL/NN)
32. connectivity test
33. Existing Enterprise Systems
34. Ideal Virtual Enterprise Systems proposed Cognitive intelligent automation solution/system
   Most of the explanations for FIGS. 0 and 1 are also applicable to FIG. 2
Official release of Master proposed Cognitive intelligent automation solution/system Artificial intelligence Database (27) is released every 3 months (28) and with external events/systems (29), the Cognitive systems—Basic (21), Advanced (22), ideal_virtual (34) and virtual_company (10) are reworked and all checklists, reports, roadmaps are regenerated
The following Machine Learning/Robotic Process Automation BOTS software roBOTS/Virtual agents is used in PreBuild to generate and fine-tune proposed Cognitive intelligent automation solution/system Basic, Advanced, Ideal_Virtual and Virtual_company cognitive systems.
   a. BIS_AttachmateRobotic Process Automation To setup config tables and the proposed Cognitive intelligent automation solution/system for the customer —industry, company, geography, country or multi-national setup
   b. BIS_AnalyzelSROA To analyze existing customer information systems, read system landscape directory (SLD) and setup detailed configuration including various adapters (ecommerce, Enterprise Resource Planning etc.)
   c. BIS_SSOTestRobotic Process Automation Detailed Single Sign-On (SSO) Setup with customer systems using SSO, do connectivity and semantic test
   d. BIS_Cognitive_SysRobotic Process Automation on Cloud/On-premise including license type (# of systems, modules, interfaces, BI Sources, Reports, countries, employees, size, complexity, # products/Services, ecommerce, Enterprise Resource Planning, Supply Chain Management, Master Data Governance, Forecasting, Business Intelligence
   e. BIS_Analyze_Mission_toActionRobotic Process Automation to setup, analyze Missions to Goals & Objectives to various information systems to support it
   f. BIS_InfrastructureRobotic Process Automation to analyze infrastructure setup, issues at hand, potential for fine tuning, SLA monitoring
   g. BIS_eCommerceAna_Robotic Process Automation Hybris setup ecommerce, analyze complexities, Issues, potential improvements
   h. BIS_IndSolnAnaRobotic Process Automation to analyze industry specific solution, Issues, potential improvements etc.
   i. BIS_Enterprise Resource Planning_SAPRobotic Process Automation to analyze Enterprise Resource Planning system all modules from Sales & Distribution, Procurement, Finance, controlling, Production planning, Master data mgmt. and governance, Product life cycle management
   j. BIS_Competitive_AnaRobotic Process Automation to do competitive analysis and derive potential intelligence reports
   k. BIS_AnaLOBRobotic Process Automation to analyze current Lines of Business (LoB) Issues, potential opportunities
   l. BIS_AnaPLMRobotic Process Automation to analyze product/service offerings, issues, opportunities
   m. BIS_AnaBIRobotic Process Automation to analyze current Business Intelligence (BI) System, Issues, possible improvements
   n. BIS_IntegrationRobotic Process Automation to analyze cross system intelligence issues, opportunities
   o. BIS_VirtualCompanyRobotic Process Automation to analyze all potential BI opportunities for the ideal company setup
   p. BIS_VirtualGapAnaRobotic Process Automation to analyze current BI initiatives and what is possible, reports to mitigate the gaps
   q. BIS_AnaWFLRobotic Process Automation to analyze synchronization needs between customer's proposed Cognitive intelligent automation solution/system and the Master proposed Cognitive intelligent automation solution/system

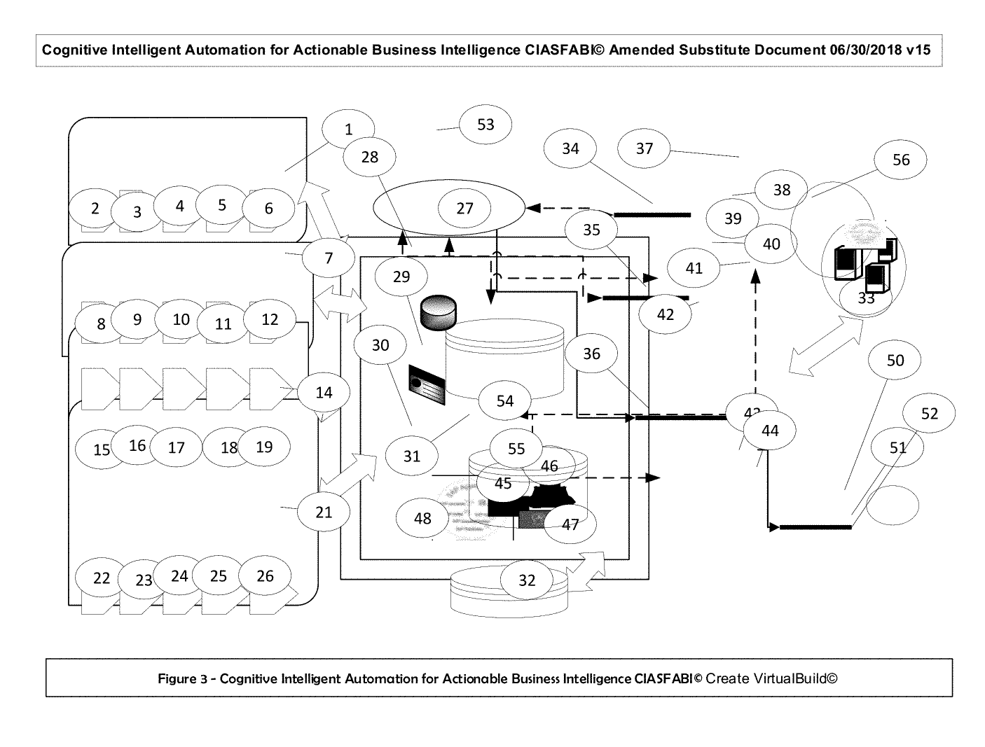

FIG. 3—Steps to Create Virtual Build System
1. Company
2. Vision
3. Mission
4. Objectives
5. Strategy
6. Action Plan
7. Existing Systems
8. Enterprise Resource Planning, eCommerce, Business Warehouse (BW) etc.
9. Industry Solution
10. Core Business Process, Reports, Interfaces (RICEF)
11. Automation Opportunities
12. Priorities
13.
14. Best Practice Gaps—Inter-Intra Industry
15. Most used Business Process in the industry
16. Most used Business Process across the industries
17. Core Business Processes
18. Automation Opportunities
19. User input Priorities
20.
21. User/Management Input-Prioritization
22. Infrastructure
23. Product Portfolio Choices
24. Core Business Process, Reports, Interfaces (RICEF) Choices
25. Automation Opportunities
26. User input Priorities
27. Cognitive Intelligent Automation Setup Wizard
28. Cognitive Automation Analyzer
29. Company Configuration
30. Company Knowledgebase
31. Governance
32. Master proposed Cognitive intelligent automation solution/system
33. Company_Virtual_proposed Cognitive intelligent automation solution/system
34. License Validation Phase
35. Discovery Phase
36. Implementation Phase
37. Enterprise Resource Planning, eCommerce, Business Warehouse etc.
38. Manufacturing Systems Product Lifecycle Management, Big Data
39. Identify Opportunity Matrix
40. Understand Platform Specifics
41. Prioritize based on Benefits/Customer Inputs
42. Quick wins complexity
43. Understand Platform Specifics
44. Prioritize based on Benefits/Customer Inputs
45. NN
46. Robotic Process Automation
47. Cognitive
48. SAP Applications
49.
50. Moderate
51. Medium
52. Futuristic
53. VirtualBuild Analyzer
54. PreBuild_BOTS software roBOTS/Virtual agents proposed Cognitive intelligent automation solution/system Basic
55. proposed Cognitive intelligent automation solution/system Advanced
56. Ideal Virtual Enterprise Systems proposed Cognitive intelligent automation solution/system
   Most of the explanations for FIGS. 0, 1 and 2 are also applicable to FIG. 3
The proposed Cognitive intelligent automation solution/system Cognitive Intelligent Automation Setup Wizard/Automation analyzer wizard using Artificial Intelligence, Machine Learning/Robotic Process Automation, Neural Networks, analyze the Company profile (vision (2), mission (3), objectives (4), Strategy (5), Action Plan (6)), Existing systems (Enterprise Resource Planning, eCommerce, Customer Relationship Management, BW (8), Industry Solution (9). Core Business Process, Reports, Interfaces (RICEF) (10), Automation Opportunities (11), Priorities (12)), Gaps in Best Practice for Inter and Intra Industry (14) (Most used business process within the industry (15), Most used business process across the industries (16), Core business process (17), Automation opportunities (18), UserInput Priorities (19), User Management Input Prioritization (21) (Infrastructure (22), Product portfolio choices (23), RICEF Choices (24), Automation opportunities (25), UserInput Priorities (26), to produce the ideal target system called Ideal_virttual and can also be the target system for the company called CompanyVirtual© using the process VirtualBuild©, as orchestrated by the Master proposed Cognitive intelligent automation solution/system which is hosted in a datacenter.
Cognitive Intelligent Automation SetupWizard has three different phases
   License validation Phase (34) Machine Learning/Robotic Process Automation BOTS software roBOTS/Virtual agents for Enterprise Resource Planning, eCommerce, Customer Relationship Management, BW, Manufacturing systems, Product Lifecycle Management (PLM), Big Data Analytics (37) (38) depending on what licensing were purchased by customer.
   During Discovery Phase (35), identifies the Opportunity (39), understand platform specifics (40) and finalize priorities based on benefits and customer input (41)
   During Implementation Phase (36), Produces a Quickwins based virtual company solution (42), different virtual company solution depending on the complexity (Moderate (50), Medium (51) and Futuristic (52). The virtual company solution is Ideal Virtual Enterprise Systems proposed Cognitive intelligent automation solution/system (56) (for complexity as Futuristic (52)) and it can be the chosen target system—Company_virtual_proposed Cognitive intelligent automation solution/system (33) which can be Vitual_company on Quickwins/Moderate/Medium.

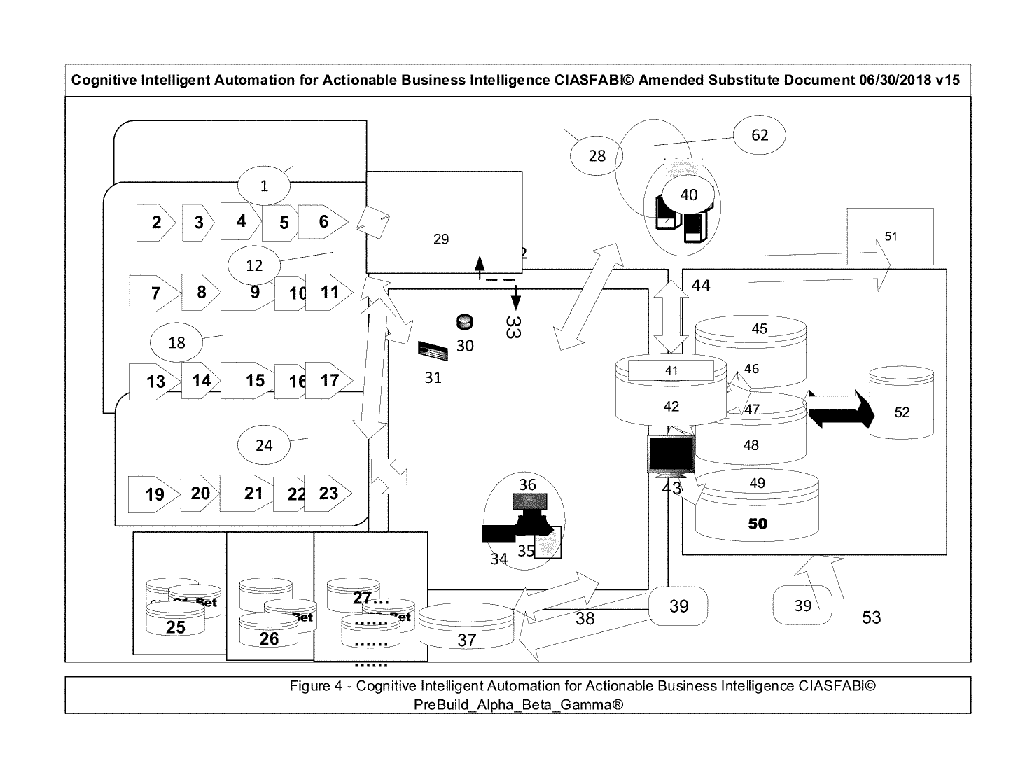

FIG. 4—Steps to Create PreBuild_ABG Systems
1 Company
2 Vision
3 Mission
4 Objectives Strategy
6 Action Plan
7 Enterprise Resource Planning (ERP), eCommerce, Business Warehouse etc.
8 Industry Solution
9 Core Business Process, Reports, Interfaces (RICEF)
10 Automation Opportunities
11 Priorities
12 Existing Systems
13 Most used Business Process in the industry
14 Most used Business Process across the industries
15 Core Business Processes
16 Automation Opportunities
17 User input Priorities
18 Best Proactive Gaps—Inter-Intra Industry
19 Infrastructure
20 Product Portfolio Choices
21 RICEF Choices
22 Automation Opportunities
23 User input Priorities
24 User/Mgmt. Input-Prioritization
25 C1_ABGSystem
26 C2_ABGSystem
27 C3_ABGSystem
28 Prebuild Analyzer
29 Cognitive Intelligent Automation Prebuild Wizard
30 Company Configuration
31 Company Knowledgebase
32 Cognitive Automation Analyzer
33 Governance
34 Neural Networks (NN)
35 Robotic Process Automation
36 Cognitive
37 Master proposed Cognitive intelligent automation solution/system
38 Releases every 3 months
39 External Events
40 Company_Virtual_proposed Cognitive intelligent automation solution/system
41 Robotic Process Automation_BOTS_0001 Robotic Process Automation_BOTS_9999
42 PreBuild_BOTS proposed Cognitive intelligent automation solution/system
43 Monitor in Progress
44 Company1_ABGSystem
45 Quickwins with Robotic Process Automation Artificial intelligence NN
46 Company1_Alpha_proposed Cognitive intelligent automation solution/system
47 Moderate with Robotic Process Automation Artificial intelligence NN
48 Company1_Beta_proposed Cognitive intelligent automation solution/system
49 Complex with Robotic Process Automation Artificial intelligence NN
50 Company1_Gama_proposed Cognitive intelligent automation solution/system
51 Report to C level Executives—Checklist, Roadmaps etc.
52 Company Info Systems
53 Trigger Alerts for downloading latest version available
54
55
56
57
58
59
60
61
62 Ideal Virtual Enterprise Systems proposed Cognitive intelligent automation solution/system
   Most of the explanations for FIGS. 0, 1, 2 and 3 are also applicable to FIG. 4
The proposed Cognitive intelligent automation solution/system Automation analyzer wizard (29) along with PreBuild ABG analyzer using Artificial Intelligence, Machine Learning/Robotic Process Automation, Neural Networks, analyze the Company profile, Existing systems, Gaps in Best Practice Inter and Intra Industry to produce the ideal target system called CompanyVirtual© using the process VirtualBuild©, as orchestrated by the Master proposed Cognitive intelligent automation solution/system which is hosted in a datacenter.
The quick wins process generates Company1_Alpha_proposed Cognitive intelligent automation solution/system (25), The moderate process generates Company1_Beta_proposed Cognitive intelligent automation solution/system (26) and Complex process generate Company1_Gama_proposed Cognitive intelligent automation solution/system (27). The futuristic process generates Ideal_Virtual_proposed Cognitive intelligent automation solution/system (62). These Company1_ABG_Systems as orchestrated by Master proposed Cognitive intelligent automation solution/system interact with existing Customer's information systems, to generate various reports and constantly reduce the gaps with Ideal_virtual system (62) and strive to eventually become the chosen Virtual_company target system (40).

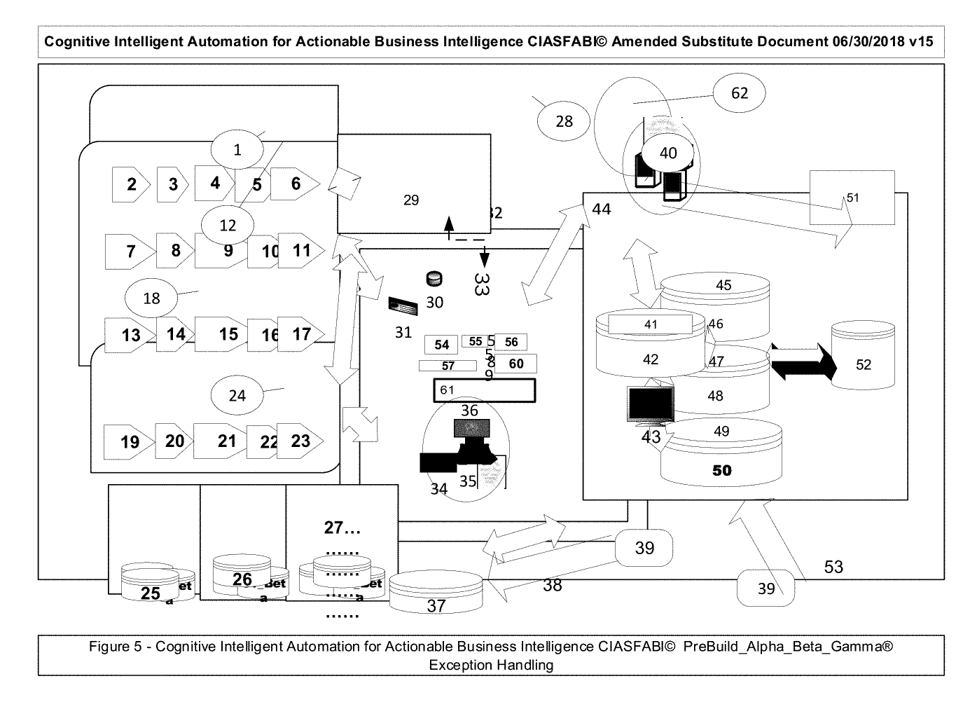

FIG. 5—Steps to Create PreBuild_ABG Systems—Exception Handling
1 Company
2 Vision
3 Mission
4 Objectives
5 Strategy
6 Action Plan
7 Enterprise Resource Planning (ERP), eCommerce, Business Warehouse etc.
8 Industry Solution
9 Core Business Process, Reports, Interfaces (RICEF)
10 Automation Opportunities
11 Priorities
12 Existing Systems
13 Most used Business Process in the industry
14 Most used Business Process across the industries
15 Core Business Processes
16 Automation Opportunities
17 User input Priorities
18 Best Proactive Gaps—Inter-Intra Industry
19 Infrastructure
20 Product Portfolio Choices
21 RICEF Choices
22 Automation Opportunities
23 User input Priorities
24 User/Mgmt. Input-Prioritization
25 C1_ABGSystem
26 C2_ABGSystem
27 C3_ABGSystem
28 Prebuild Analyzer
29 Cognitive Intelligent Automation Prebuild Wizard
30 Company Configuration
31 Company Knowledgebase
32 Cognitive Automation Analyzer
33 Governance
34 Neural Networks (NN)
35 Robotic Process Automation (RPA)
36 Cognitive
37 Master proposed Cognitive intelligent automation solution/system
38 Releases every 3 months
39 External Events
40 Company_Virtual_proposed Cognitive intelligent automation solution/system
41 Robotic Process Automation_BOTS_0001 Robotic Process Automation_BOTS_9999
42 PreBuild_BOTS_proposed Cognitive intelligent automation solution/system
43 Monitor in Progress
44 Company1_ABGSystem
45 Quickwins with Robotic Process Automation Artificial intelligence NN
46 Company1_Alpha_proposed Cognitive intelligent automation solution/system
47 Moderate with Robotic Process Automation Artificial intelligence NN
48 Company1_Beta_proposed Cognitive intelligent automation solution/system
49 Complex with Robotic Process Automation Artificial intelligence NN
50 Company1_Gama_proposed Cognitive intelligent automation solution/system
51 Report to C level Executives—Checklist, Roadmaps etc.
52 Company Info Systems
53 Trigger Alerts for downloading latest version available
54 Potential Automation Scenarios 1-9999
55 Predictive
56 Robotic Process Automation BOTS 0001-Robotic Process Automation BOTS 9999
57 Exception Robotic Process Automation_BOTS_1_to_999
58 TRUE
59 FALSE
60 Attach Robotic Process Automation BOTS to EXCPTN_Robotic Process Automation BOTS (e.g. Robotic Process Automation_BOTS_0908 with Excptn_Robotic Process Automation_002
61 Automation Exception handling with Deep Learning Wizard
62 Ideal Virtual Enterprise Systems proposed Cognitive intelligent automation solution/system
   Most of the explanations for FIGS. 0, 1, 2, 3 and 4 are also applicable to FIG. 5
Most of the explanation for FIG. 4 is also applicable for FIG. 5
The Customer's proposed Cognitive intelligent automation solution/system is further fine-tuned by Automation_Exception_handling_with_Deep_Learning_Wizard (61) which initially uses predictive scenarios for automation and if that may not work for this customer, the deep learning wizard understands the exceptions and uses it in the future iterations to provide better automation capability.
Finally, all external events affecting the company will be analyzed and advice will be provided from the Master proposed Cognitive intelligent automation solution/system to customer's proposed Cognitive intelligent automation solution/system, each iteration of the product will provide superior intelligence than the previous one.

### DETAILED DESCRIPTION

The Cognitive Intelligent Automation system proposed Cognitive intelligent automation solution/system will have the following characteristics
Foundation Architecture—SAP Leonardo S4HANA (latest offering on Artificial intelligence and Enterprise Resource Planning platform from a vendor SAP) based Internet of Things, Artificial intelligent environment, a combination of intelligent technologies, services, and industry solutions to provide innovative customized solutions for each customer
On-premise or cloud offering
License purchased will determine the customer's proposed Cognitive intelligent automation solution/system including all adapters and mini-cognitive systems.
Custom tools, methodology and consulting to partners and customers will be provided to fine tune the proposed Cognitive intelligent automation solution/system, for the customer's unique enterprise system(s).
Customizable Adapters to work with popular eCommerce solution (e.g. SAP Hybris), Enterprise Resource Planning (e.g. SAP ECC/S4HANA), Business Intelligence, manufacturing systems, Big Data will be prototyped
Leverage industry wide, inter-industry, intra company, intercompany business intelligence historically, the present and future initiatives
A virtual (ideal) company with the necessary Business Intelligence reports, checklists, Roadmaps etc. will be generated by proposed Cognitive intelligent automation solution/system and the gaps in the existing initiatives will be identified and actionable reports will be generated to assist in closing the gap.
Feedback control mechanism will be provided to fine tune the Cognitive Intelligent Automation systems, based on change in market place, laws, technology, etc. due to external events.
Cognitive Intelligent Automation Solution proposed Cognitive intelligent automation solution/system will cover wide areas—corporate vulnerabilities and cybersecurity risks, comprehensive audit, next generation of products and services, corporate governance for Board of Directors, shareholders, employees etc., and various strategic, operational and tactical business intelligence for actions by employees, executives, Board of Directors, Alignment of corporate mission, goals & objectives with suitable proposed information system solutions etc.

The invention claimed is:

1. A method and systems comprising cognitive intelligent automation systems (proposed Cognitive intelligent automation solution/system), that transforms any customer's information systems to provide actionable business intelligence at every stage of the evolution to the ultimate target system, the best in class in the industry always adjusting to internal and external events to take advantage of opportunity, to provide 24×7 Reports, Checklists, Roadmaps and advice on Strategic, tactical and operational execution, supporting customer's business systems (ecommerce, Enterprise Resource Planning package, Customer Relationship Management system, Analytics etc.) to Executive management, C level executes, end-to-end Lines of Business (LOB), senior management and Board of Directors.

2. The method and system (proposed Cognitive intelligent automation solution/system) of claim 1, providing actionable business intelligence reports, checklists, roadmaps to all C level executives, Board of Directors and all executive management on Business Intelligence, information system Architecture, Products & Services, Corporate compliance, vulnerability and opportunity assistance (e.g. cloud migration readiness roadmap).

3. The method and system (proposed Cognitive intelligent automation solution/system) of claim 1, Actionable business intelligence products include Predicting infrastructure needs from present to 1-2-5 years, new products & services, new Mergers & Acquisition opportunities, Actionable strategic, operational intelligence, predicting & mitigating corporate vulnerabilities, corporate governance for Board of Directors, employees, shareholders and stakeholders.

4. The method and system (proposed Cognitive intelligent automation solution/system) of claim 1, identifying the automation opportunity within the current application systems (e.g. SAP ECC/S4HANA) compares with best practices within same industry and across all industries and other companies in the same industry.

5. The method and system (proposed Cognitive intelligent automation solution/system) of claim 1, identifying the business process, and/or other software that might be enabled (which are not at present) based on the best practices within same industry and across all industries and other companies in the same industry.

6. The method and system (proposed Cognitive intelligent automation solution/system) of claim 1, transforming Customer's System (say SAP based enterprise applications) with a superior wisdom provided for the entire enterprise 24×7 using state-of-the-art Artificial intelligence using Deep Learning and Neural Networks and Cognitive Automation with Machine Learning/Robotic Process Automation Software robots—purpose built and quick to deploy (BOTS software roBOTS/Virtual agents).

7. The method and system (proposed Cognitive intelligent automation solution/system) of claim 1, Analyzing external events (change in market place, laws, technology) affecting the company and advice will be provided from the Master proposed Cognitive intelligent automation solution/system hosted in a datacenter to customer's proposed Cognitive intelligent automation solution/system, each iteration of the product will provide superior intelligence than the previous one.

8. The method and system (proposed Cognitive intelligent automation solution/system) of claim 1, Fine-tuning of interaction with the systems, scope of business intelligence and automation solutions needed in various areas will be identified in various phases to generate series of Mini-Cognitive Intelligent Automation Adapters/Systems will provide Actionable Business intelligence and any corrections can be fed into (Master proposed Cognitive intelligent automation solution/system) Cognitive solution setup, to generate better business intelligence in the next iteration(s).

9. The method and system (proposed Cognitive intelligent automation solution/system) of claim 1, A virtual ideal system representing the ultimate set of information systems for the company based on best available commercial application systems available in the industry, competitive companies across the world, will be created as part of Cognitive intelligent automation system to represent the target computing environment of the customer's information systems. but also, how to get there every step of the way seamlessly, very similar to what autonomous cars take you to the destination, except in this case, information systems that run your business—eCommerce, Enterprise Resource Planning, Customer Relationship Management, Analytics etc.

10. The method and system (proposed Cognitive intelligent automation solution/system) of claim 1, the Virtual Ideal system will be compared with existing customer's information systems e.g. SAP ECC version 6 enhancement pack 4, SAP Hybris 5.5 etc.) 24×7, Capability Maturity Ranking) will be provided to customer real-time identifying the gaps in their existing initiatives and approach and provide suitable reports to close the gaps in the target environment.

11. The method and system (proposed Cognitive intelligent automation solution/system) of claim 1, a comprehensive step-by-step procedure/system to produce a semi-autonomous, self-curing customizable customer's information system.

12. The method and system (proposed Cognitive intelligent automation solution/system) of claim 1, Constant monitoring and adaptation of external and internal events (24×7) to self-adjust the customer's target system and adjust all the reports, roadmaps etc. in order for the customer's information system to take advantage of all events that can significantly bring benefit to the company and its stakeholders.

13. The method and system (proposed Cognitive intelligent automation solution/system) of claim 1, The Master (proposed Cognitive intelligent automation solution/system) will also have external information system intelligence—ongoing world news, tax rates, changes worldwide, Mergers & Acquisitions, new technology innovation etc. and some of the customers (proposed Cognitive intelligent automation solution/system) system will also get advice/tips on other external events that are likely to affect the company—SWOT (Strength, weakness, opportunity, threats) analysis incl. from competition, technology changes, tax changes, political changes incl. war etc.

14. The method and system (proposed Cognitive intelligent automation solution/system) of claim 1, Right from licensing to customers, state-of-the art technologies such as crypto key will be generated for the configuration of the customer's enterprise information system (e.g. SAP eCommerce (Hybris),—eCommerce, Enterprise Resource Planning, Customer Relationship Management, Analytics Governance and Regulatory systems, Master Data Governance, Industry Solutions, Supplier management solutions (e.g. SAP Ariba), Travel management solutions (e.g. SAP Concur) (Subcontractor solutions (e.g. SAP Field Glass) and other SAP based solutions that will generate appropriate intelligent adapters at customer site based on the (Master proposed Cognitive intelligent automation solution/system) that will be hosted in a data center using the license key to generate configuration Database, that will be used the proposed Cognitive intelligent automation solution/system as the reference.

15. The method and system (proposed Cognitive intelligent automation solution/system) of claim 1, the (proposed Cognitive intelligent automation solution/system) will and needs to be a learning system with additional inputs provided through Machine Learning enhanced Robotic Process Automation BOTS software roBOTS/Virtual Agents-Software Robots, manual, Artificial intelligence, machine to machine, deep learning and neural networks.

16. The method and system (proposed Cognitive intelligent automation solution/system) of claim 1, This customer's (proposed Cognitive intelligent automation solution/system) will also be synchronized with (Master proposed Cognitive intelligent automation solution/system) hosted in a datacenter, so the entire set of products for the customer's target system will get better over a period of time.

17. The method and system (proposed Cognitive intelligent automation solution/system) of claim 1, that can be adapted to different company's enterprise information system architecture (COTS such as SAP to begin with and others in the future) for any industry/company operating in any Geography/Country.

18. The method and system (proposed Cognitive intelligent automation solution/system) of claim 1, The custom methodology and systems will generate series of Cognitive Intelligent automation systems with Robotic Process Automation BOTS-software roBOTS/Virtual agents, Artificial intelligence, Neural networks that will handle specific automation needs of a business enterprise to provide actionable business intelligence—be it in eCommerce, Enterprise Resource Planning, Customer Relationship Management, Analytics etc. for Corporate Governance or specific Business Intelligence (BI) reports to Board of Directors' a mini-Cognitive Intelligent Automation system for ecommerce (e.g. SAP Hybris) and another mini-Cognitive Intelligent Automation system for Enterprise Resource Planning (e.g. SAP S4HANA) etc. will be generated that will cater to that area of the enterprise application.

19. The method and system (proposed Cognitive intelligent automation solution/system) of claim 1, The set of application specific (ecommerce—e.g. SAP Hybris) adapters will generate mini Cognitive system that will be responsible for generating all Business intelligence reports, checklists, roadmaps for eCommerce functionality, other application specific adapters e.g. S4HANA (Enterprise Resource Planning), Industry Solution (IS—e.g. Hitech), Corporate Mission will generate mini Cognitive Intelligent Automation systems to generate Business intelligence for various Lines of Business (e.g. Enterprise Resource Planning adapter).

20. The method and system (proposed Cognitive intelligent automation solution/system) of claim 1, further amenable to learn further by neural networks, Artificial intelligence, Machine Learning/Robotic Process Automation BOTS—software roBOTS/Virtual agents—Software Robots, In Memory computing technology (e.g. SAP S4HANA), Internet of Things and different adapter & sensors with the sole purpose of providing 24×7 actionable business intelligence via reports, checklists, roadmaps to all C level executives, Board of Directors and all executive management.
